(19) United States
(12) Patent Application Publication
(10) Pub. No.: US 2007/0277439 A1
(43) Pub. Date: Dec. 6, 2007

(54) Rotating barrier

(76) Inventors: Gregor Ponert, Salsburg (AT); Thomas Grasmann, Groding (AT)

Correspondence Address: FLYNN THIEL BOUTELL & TANIS, P.C., 2026 RAMBLING ROAD, KALAMAZOO, MI, 49008-1631, US

(21) Appl. No.: 11/809,380

(22) Filed: Jun. 1, 2007

(30) Foreign Application Priority Data
Jun. 6, 2006 (DE) 10 2006 026 221.2

(51) Int. Cl. E05D 15/02

(52) U.S. Cl. 49/44; 49/42

(57) ABSTRACT

A rotating barrier having a rotating arm assembly (1) has at least one blocking arm (2) which is formed at least over part of its length by a springy core piece (14) and is provided with an outer sheath (25).

This invention relates to a rotating barrier for access control which has a rotating arm assembly provided with at least one flexibly formed blocking arm.

Such a rotating barrier is known from DE 10 2004 013 965 B3. The blocking arm therein releases the access in its basic position, and the rotating arm assembly is actuated by a motor driven by a people sensor and an access authorization reader to rotate the blocking arm into the access so as to block it upon detection of a person but without valid reading of an access authorization.

When the blocking arm is rotated out of the basic or open-gate position into the blocking position because no valid access authorization has been read, a skier for example can hit the blocking element at high speed and thereby hurt himself. Accordingly, it is already provided according to DE 10 2004 013 965 B3 to equip the blocking arm with a padding and/or make it resilient, e.g. out of rubber-elastic material.

On the other hand, it must not be recognizable optically or in any other way that the blocking arm gives way, since this could otherwise destroy the actual purpose of the rotating barrier, namely to prevent unauthorized access.

It is therefore the problem of the invention to provide a blocking arm whose flexibility is only recognizable when collision with it would lead to injuries.

This is obtained according to the invention by the rotating barrier characterized in claim 1. Advantageous embodiments of the invention are rendered in the sub-claims.

According to the invention, the flexibly formed blocking arm has a springy core piece extending at least over part of the length of the blocking arm. The springy core piece has such high spring stiffness that the blocking arm gives way only when a collision with a person produces forces that would lead to injury. This prevents the resilience of the blocking arm from being recognizable in normal operation, that is, when a person hits the blocking arm at normal walking speed for example. Moreover, the blocking arm is provided with an outer sheath so as not to allow its flexible formation to be optically recognizable.

The springy core piece can be formed by an element made of rubber-elastic material and/or a spring.

The rubber-elastic element can be a circular, prism-shaped or otherwise formed rod made of rubber-elastic material. The spring can be formed by a helical spring and/or a springy, for example circular or prism-shaped rod. It is also possible to use for example a leaf spring if it is so disposed in the blocking arm as to bend upon collision with a person.

The springy core piece preferably has hinged-together bodies which are held together under tension by the rubber-elastic element and/or the spring. The bodies can be made of a hard, i.e. itself not rubber-elastic, plastic, for example polyurethane, polyamide, polyolefins and similar relatively hard polymers. The rubber-elastic element or the spring can be disposed on the outer side of the bodies, but the rubber-elastic element or the spring preferably extends in the longitudinal direction of the blocking arm through the hinged-together bodies. The rubber-elastic element can be made of a thermoplastic elastomer, for example on the basis of polyethylene.

To be hinged together, the bodies are preferably provided with projections engaging recesses, the body at one end of the springy core having a recess and at the other end a projection, while the middle bodies disposed therebetween are each provided with a recess and a projection.

The bodies are preferably of cylindrical form. The recesses can also be of cylindrical form, while the projections, for hinged movability of the bodies, taper slightly for example conically or in arched fashion from the particular body on which they are provided into the recess which they engage.

The force with which the bodies are braced is preferably adjustable. When a rubber-elastic element is used for bracing the bodies, the rubber-elastic element can be stretched accordingly for adjusting said force. The thus stretched rubber-elastic element is then fixed at both ends to the two bodies at the ends of the springy core for example with transverse bolts or pins.

When the springy core has a compression spring, a cable or similar traction means can be guided through the compression spring for adjusting the bracing of the bodies, each end of said cable being connected to a threaded rod onto which a nut is screwed for adjusting the compression of the compression spring, on which one or the other end of the compression spring is supported.

The outer sheath with which the blocking arm is provided is preferably made of foam rubber or another rubber-elastic foam material.

The rotating arm assembly is preferably rotated by a motor, in particular an electromotor. It can have one, two or more blocking arms. The rotating arm assembly can have a rotation axis inclined from the horizontal for example by about 30 to 40° e.g. with a single blocking arm or with two blocking arms enclosing an angle of about 120 or 240°, as known from WO 97/18379 or EP-A-961005, or a vertical rotation axis with one, two or more blocking arms according to WO 97/18379.

The inventive rotating barrier is suitable in particular for open-gate access control apparatuses having a rotating arm assembly with one or two blocking arms. The rotating arm assembly is moved here by a motor which is driven by a people sensor and an access authorization reader. When the people sensor detects a person and the access authorization reader at the same time reads a valid access authorization, the rotating arm assembly remains in its basic or open-gate position in which e.g. the one or both blocking arms release the access. However, when a person is detected by the people sensor without a valid reading of the access authorization having been carried out, the motor is driven and thus the, or one, blocking arm rotated into the access to block it.

The invention prevents for example a skier or other person who is approaching the blocking arm extending across the access at high speed from being injured by the force of the impact when no valid access authorization is read and thus the access suddenly blocked by the blocking element. For open-gate control apparatuses it is customary to use non-contact-type access authorization readers, in particular readers for RFID transponders with the access authorization stored thereon. The people sensor can be formed for example as an optoelectronic sensor.

However, the inventive rotating barrier is also suitable for conventional access control apparatuses in which a blocking arm of the rotating arm assembly blocks the access in the basic position and releases it only after a valid access authorization is read. Such access authorization apparatuses can be provided with a people sensor which detects a person located in the area of the blocking plane which the blocking arm barring the access assumes. When a valid access authorization has been read by the access authorization reader and the people sensor detects a person, the motor of the rotating barrier is driven and the access thus released. The rotating arm assembly is then rotated further to block the access again.

When such an access is formed for wheelchairs, it can happen that the blocking arm hits the person in the wheelchair from behind and hurts him upon further rotation of the rotating arm assembly. Since such an access is formed to be appropriately wide and thus the blocking arms have a corresponding length, considerable lever forces can moreover occur. The inventive formation of the blocking arm can also minimize the risk of injury in this case.

Hereinafter the invention will be explained in more detail by way of example with reference to the enclosed drawing. The figures are described as follows:

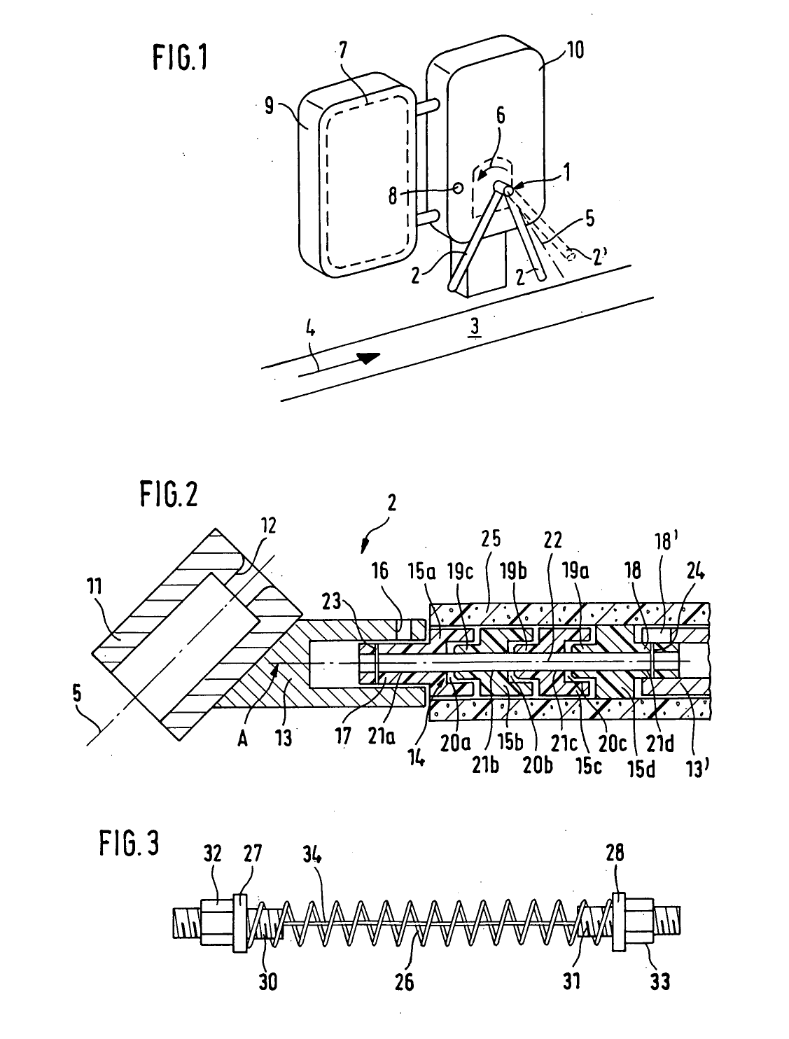

FIG. 1 a perspective view of an access control apparatus having a rotating arm assembly with two blocking arms;

FIG. 2 the part of the blocking arm facing the rotation axis of the rotating arm assembly according to FIG. 1 in longitudinal section;

FIG. 3 a side view of the elastic core piece of the blocking arm according to another embodiment but without hinged bodies and outer sheath.

According to FIG. 1, an access control apparatus has a rotating arm assembly 1 with two blocking arms 2 for blocking the access lane 3 which is passed in the direction of the arrow 4. The rotating arm assembly 1 is rotatable around an axis 5 inclined e.g. by 35° from the horizontal. The blocking arms 2 enclose an angle of e.g. 45° with the rotation axis 5.

FIG. 1 shows the blocking arms 2 in the open-gate basic position in which it releases the access. Rotation of the rotating arm assembly 1 according to the arrow 6 causes a blocking arm 2 to be rotated upward into the position 2′ shown by dashed lines in FIG. 1 and the access 3 thus blocked. The motor (not shown) of the rotating arm assembly 1 is driven for this purpose by an access authorization reader with an antenna 7 and a people sensor 8 in housings 9 and 10, respectively. The access authorization reader is formed for reading an access authorization which is stored on an RFID transponder. This means that the one blocking arm is rotated into the blocking position 2′ only when the people sensor 8 detects a person but the access authorization reader does not read a valid access authorization.

According to FIG. 2, the blocking arm 2 is fastened to a hub 11 which is slipped rotationally fast on a shaft (not shown) for rotating the rotating arm assembly 1. For axially fastening the hub 11 to the shaft, a screw bolt (not shown) is provided which penetrates the bore 12. A tube section 13 is fastened to the hub 11. The hub 11 and the tube section 13 are made of metal and are welded together for example.

The short tube section 13 is followed by a springy core piece 14. The core piece 14 consists of hinged-together bodies 15a to 15d. The bodies 15a and 15d form the two ends of the core piece 4 between which the middle bodies 15b and 15c are disposed.

The body 15a has a cylindrical pin 17 which is inserted into the tube section 13 on the hub 11 and fixed with a screw (not shown) which penetrates the bore 16. Likewise, the body 15d is provided with a cylindrical pin 18 which is inserted into a further metal tube section (not shown) and fixed accordingly therein e.g. with a screw which penetrates the bore 18′.

For hinging together the bodies 15a to 15d, the body 15d and the middle bodies 15b and 15c have a projection 19a to 19c and the body 15a and each middle body 15b and 15c a recess 20a to 20c, the projections 19a to 19c engaging the recesses 20a to 20c of the adjacent body 15a to 15d.

The bodies 15a to 15d are made of plastic. They have a cylindrical circumferential area coaxial to the longitudinal axis A of the blocking arm 2. The recesses 20a to 20c are also formed substantially cylindrically and coaxially to the longitudinal axis A, while the projections 19a to 19c are likewise formed coaxially but taper away from the respective body 15a to 15c. For all bodies 15a to 15d to be aligned coaxially, the portion of the projections 19a to 19c facing the respective body 15a to 15c is provided with a diameter corresponding to the diameter of the recess 20a to 20c which it engages.

The bodies 15a to 15d are provided with coaxial through bores 21a to 21d having extending therethrough a rod-shaped element 22 made of rubber-elastic material, e.g. thermoplastic elastomer. The element 22 is stretched and fixed e.g. with pins 23, 24 to the end bodies 15a and 15d to brace the bodies 15a to 15d together.

An outer sheath 25 made of foam rubber is pushed over the springy core piece 14 and the further, only partly shown tube section 13′ at the end of the blocking arm 2 facing away from the hub 11.

In the embodiment according to FIG. 3, the springy core piece 14 has instead of the rubber-elastic element 22 a compression spring 26 which extends through the through bores 21a to 21d of the bodies 15a to 15d not shown in FIG. 3. The compression spring 26 is supported at its ends on counterwashers 27, 28 which are each slipped on a threaded bolt 30, 31 and fixed by nuts 32, 33 screwed onto the threaded bolts 30, 31. The threaded bolts 30, 31 are interconnected by a cable 34 extending through the helical spring 26. At their ends onto which the nuts 32, 33 are screwed, the threaded bolts 30, 31 protrude out of the end bodies 15a, 15d to permit adjustment of the compression and thus the stiffness of the compression spring 26.

FIG. 2 shows only two middle bodies 15b, 15c. However, in reality more middle bodies are preferably used, for example three to eight. The length of the middle bodies 15b, 15c without projections 19b, 19c can be for example 0.5 to 3 cm.

1. A rotating barrier having a rotating arm assembly (1) with at least one flexibly formed blocking arm (2), characterized in that the flexibly formed blocking arm (2) has a springy core piece (14) extending at least over part of its length and is provided with an outer sheath (25).

2. The rotating barrier according to claim 1, characterized in that the springy core piece is disposed between the rotation axis (5) of the rotating arm assembly (1) and the middle area of the blocking arm (2).

3. The rotating barrier according to claim 1, characterized in that the springy core piece (14) has a rubber-elastic element (22) and/or a spring.

4. The rotating barrier according to claim 3, characterized in that the spring is formed by a helical spring or a springy rod.

5. The rotating barrier according to claim 4, characterized in that the helical spring is formed as an extension spring or compression spring (26).

6. The rotating barrier according to claim 3, characterized in that the springy core piece (14) consists of hinged-together bodies (15a to 15d) which are braced by the rubber-elastic element (22) or the spring.

7. The rotating barrier according to claim 6, characterized in that the rubber-elastic element (22) or the spring extends through the hinged-together bodies (15a to 15d).

8. The rotating barrier according to claim 7, characterized in that the bodies (15a to 15d), for being hinged together, have projections (19a to 19c) engaging recesses (20a to 20c), the bodies (15d and 15a) at the two ends of the springy core piece (14) having a projection (19a) or a recess (20a) and the middle bodies (15b and 15c) disposed therebetween each having a projection (19b, 19c) and a recess (20b, 20c).

9. The rotating barrier according to claim 6, characterized in that the force with which the bodies (15a to 15d) are braced together is adjustable.

10. The rotating barrier according to claim 9, characterized in that the bracing is adjustable by the stretching of the rubber-elastic element (22).

11. The rotating barrier according to claim 9, characterized in that the bracing is adjustable by the compression of the compression spring (26).

12. The rotating barrier according to claim 1, characterized in that the outer sheath (25) is made of rubber-elastic foam material.
